(19) United States
(12) Patent Application Publication
(10) Pub. No.: US 2006/0207075 A1
(43) Pub. Date: Sep. 21, 2006

(54) CREMATION URN AND KEEPSAKE HOLDER

(75) Inventor: KENT DAVIS, VULCAN (CA)

Correspondence Address: Bay Area Patent Group, LLC, 13575 58TH ST. NORTH, SUITE 175, CLEARWATER, FL, 33760, US

(73) Assignee: LAST CHAPTER INC, VULCAN (CA)

(21) Appl. No.: 10/906,613

(22) Filed: Feb. 26, 2005

(51) Int. Cl. A61G 17/00

(52) U.S. Cl. 27/1

(57) ABSTRACT

A cremation urn and keepsake holder is provided. The urn and keepsake holder includes a housing of a general overall construction and appearance of a hard cover book and includes two book leafs which are hingidly attached to one another and which are rotatable to open the housing as a typical book would be opened. One book leaf provides a first compartment for receiving keepsake articles and can include a photograph holder. The second book leaf provides a second, hermetical sealed compartment for receiving and holding cremation remains. A container assembly can be provided for storing additional keepsake articles, and a decorative pillow can be provide for the attachment of keepsake articles. When the leafs are closed, the keepsake articles are safely retained by the housing.

### FIELD OF THE INVENTION

The present invention relates generally to storing of a loved ones cremation remains and cherished keepsake articles. More particularly, relating to a decorative cremation urn and keepsake holder for holding and preserving cremation remains and the storing of keepsake items.

### SUMMARY OF THE INVENTION

In accordance with the present invention, an apparatus for safely preserving cremation remains and storing keepsake articles is provided.

In general, in one aspect, a cremation urn and keepsake holder having a simulative appearance of a book is provide. The urn and keepsake holder includes a first book leaf, the first book leaf includes an exterior cover panel, an interior cover panel, and a side wall that is attached to and extends between the exterior cover panel and the interior cover panel so as to define a first compartment; a second book leaf hingidly attached to the first book leaf along a common adjacent edge, the second book leaf includes an exterior cover panel, an interior cover panel, and a side wall that is attached to and extends between the exterior cover panel and the interior cover panel so as to define a second compartment for receiving cremation remains, the second compartment is sealed from an exterior environment; and a container assembly, the container assembly is adapted to be sealing received by an aperture formed through the interior cover panel of the second book leaf.

In general, in another aspect, a photograph holder is formed into the exterior cover panel of the first book leaf. The photograph holder is adapted to receive and display a photograph such that the photograph is facing outwardly from the first book leaf.

In general, in another aspect, a cremation urn and keepsake holder having a simulative appearance of a book is provided. The urn and keepsake holder includes a first book leaf, the first book leaf includes an exterior cover panel, an interior cover panel, and a side wall that is attached to and extends between the exterior cover panel and the interior cover panel so as to define a first compartment; a second book leaf hingidly attached to the first book leaf along a common adjacent edge, the first book leaf includes an exterior cover panel, an interior cover panel, and a side wall that is attached to and extends between the exterior cover panel and the interior cover panel so as to define a second compartment for receiving cremation remains, the second compartment is sealed from an exterior environment, the interior cover panel of the second book leaf defining an aperture for placing cremation remains within the second compartment; and a cover plate, the cover plate is removable attached to the interior cover panel of the second book leaf to seal to seal the aperture.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the new cremation urn and keepsake holder according to the present invention;

FIG. 2 is a front elevation view of the present invention;

FIG. 3 is a perspective view showing the new cremation urn and keepsake holder in an open configuration;

FIG. 4 is a cross section view through the keepsake container assembly taken along line 4-4 in FIG. 3; and

FIG. 5 is a perspective view showing the new cremation urn and keepsake holder in an open configuration and including a decorative pillow.

The same reference numerals refer to the same parts throughout the various figures.

### DETAILED DESCRIPTION OF THE INVENTION

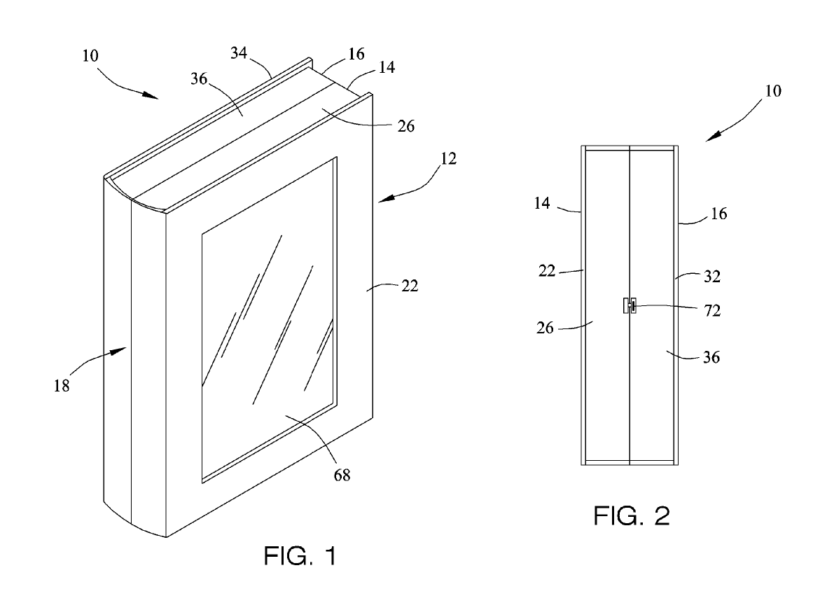

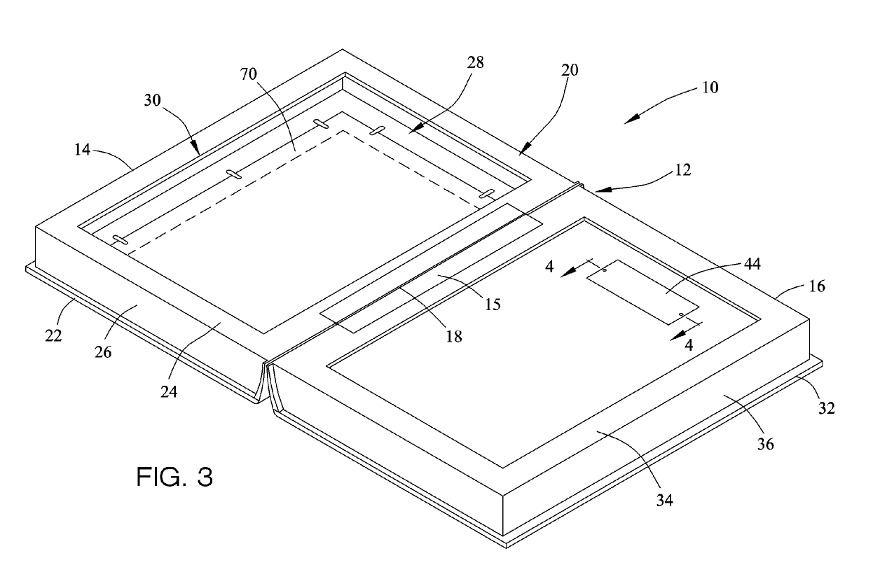

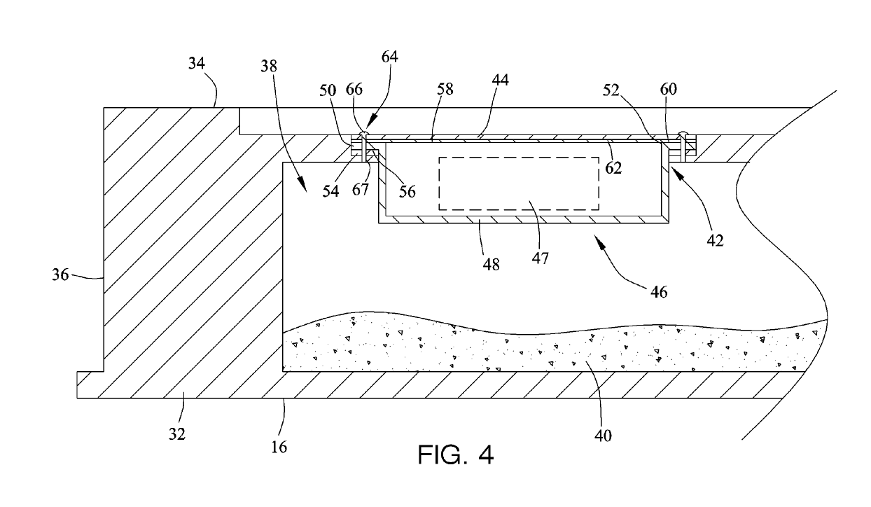

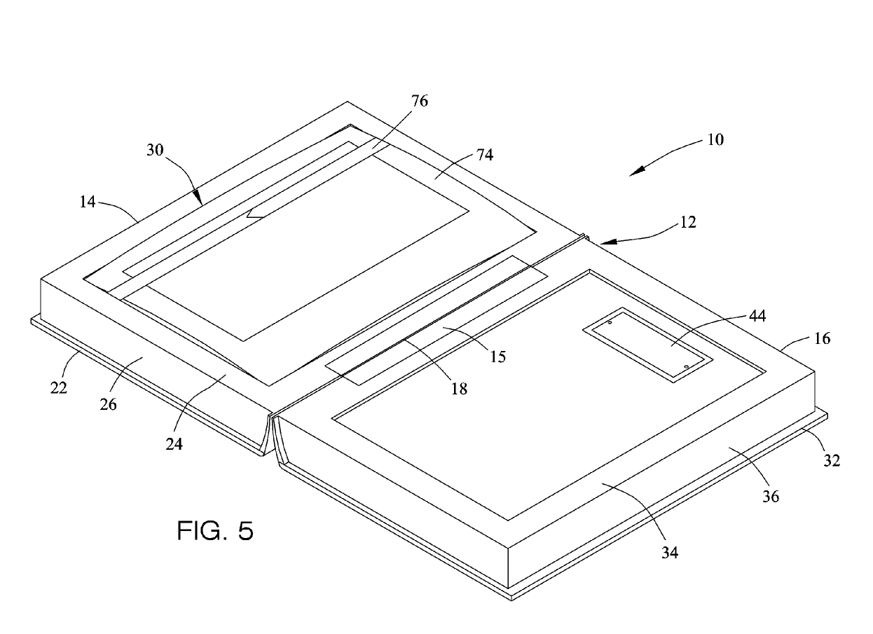

Referring now to the drawings, and particularly to FIGS. 1 through 5 thereof, a new cremation urn and keepsake holder embodying the principles and concepts of the present invention and generally designated by the reference numeral 10 will be described.

As best illustrated in FIGS. 1 through 5, the cremation urn and keepsake holder 10 generally comprises a device 10 for preserving cremation remains and for holding and safely storing keepsake articles. The device 10 includes a housing 12 having a general overall appearance of a typical hard cover book. The housing 12 includes a first book leaf 14 hingidly attached to a second book leaf 16 along a spine region 18 by a hinge 15. The first and second book leafs 14 and 16 operate as a typical book and are rotatable about the spine region 18 from a closed position to an open position, thereby open the housing 12 exposing the interior 20 thereof.

The first book leaf 14 includes an exterior cover panel 22, an interior cover panel 24 and a peripheral wall 26 which is attached to and extends between the exterior and interior cover panels. The exterior cover panel 22 together with the interior cover panel 24 and the peripheral wall 26 define a first compartment 28. The first compartment 28 is adapted to receive various keepsake articles therewithin. The interior cover panel 24 defines an opening 30 which allows an unobstructed access to the interior of the first compartment 28. The opening 30 can be of dimensions which is substantially equal to the dimensions of the interior cover panel 24.

The second book leaf 16 also includes an exterior cover panel 32, and interior cover panel 34 and a peripheral wall 36 which is attached to and extends between the exterior and interior cover panels. The exterior cover panel 32 together with the interior cover panel 34 and the peripheral wall 36 define a second compartment 38. The second compartment 38 is hermetically sealed and is for receiving the cremation remains 40 of a loved one. Loved one by definition in this US Letters of Patents relates to human and non-human relations, such affectionate relations with a loved pet. Because the second compartment 38 is hermetically sealed or in other words air and fluid tight, the cremation remains 40 can be placed directly into the second compartment 38 without the need a device or container means to house the remains.

The second book leaf 16 includes an opening 42 allowing access to the second compartment 38. The opening 42, is shown being made through the interior cover panel 34 of the second book leaf 16, however, the opening may be formed through any surface of the second book so as to allow access to the second compartment 38. A cover plate 44 is removably attached to the second book leaf 16 to cover and seal the opening 42 so that the second compartment 38 is air and fluid tight.

A container assembly 46 for providing safe storing of valuable or smaller keepsake articles, generally indicated at 47, can be sealing receiving by the opening 42. The container assembly 46 includes the cover plate 44, an open top container 48 having a flange 50 extending from the peripheral edge of the open end 52 of the open top container beyond the edge of the opening 42, a first gasket seal 54 positioned between a lower surface 56 of the flange 50 and the second book leaf 16, a second gasket seal 58 positioned between an upper surface 60 of the flange and a lower surface 62 of the cover plate 44, and a fastening means 64 for sealing securing the container assembly within the opening. The fastening means 64 can include at least one threaded fastener 66 and a cooperating threaded bore 67 formed through the second book leaf 16. The second gasket seal 58 is sized to completely cover the lower surface 62 of the cover plate 44 and is of a soft surface material, such felt.

The container assembly 46 is capable of being removed from the opening 42 allowing the placement of cremation remains 40 within the second compartment 38, and then is reinserted into the opening 42 to reseal the second compartment.

A photograph holder 68 for displaying a photograph of a loved one whose cremation remains 40 are contained by the device 10 can be provided. The photograph holder 68 is attached to or formed integrally with the exterior cover panel 22 of the first book leaf 14. The photograph holder 68 is positioned such that a photograph received by the holder is viewable from a vantage point positioned outwardly from the exterior cover panel 22. Preferably, the photograph holder 68 is accessed through the opening 30 and includes a removable backing 70 for retaining a photograph within the photograph holder.

A latch 72 can be provided for locking the first and second book leafs 14 and 16 in the closed position preventing access to the interior 20 of the housing 12. When the book leafs 14 and 16 are in the closed position, the keepsake articles contained by the housing 12 are inaccessible and are securely stored.

In a further aspect, a decorative pillow 74 can be provided which is adapted to be inserted into and received by the first compartment 28. The decorative pillow 74 is used for providing a decorative and warm support surface for the attachment of various keepsake articles. The decorative ribbon 76 can be provided along with the pillow to aid in the attachment of keepsake articles to the decorative pillow 74.

A number of embodiments of the present invention have been described. Nevertheless, it will be understood that various modifications may be made without departing from the spirit and scope of the invention. Accordingly, other embodiments are within the scope of the following claims.

What is claimed is:

1. A cremation urn and keepsake holder having a simulative appearance of a book, comprising:
a first book leaf, said first book leaf includes an exterior cover panel, an interior cover panel, and a peripheral wall that is attached to and extends between said exterior cover panel and said interior cover panel so as to define a first compartment;
a second book leaf hingidly attached to said first book leaf along a common adjacent edge, said first book leaf includes an exterior cover panel, an interior cover panel, and a peripheral wall that is attached to and extends between said exterior cover panel and said interior cover panel so as to define a second compartment for receiving cremation remains, said second compartment is sealed from an exterior environment; and
a container assembly, said container assembly is adapted to be sealing received by an aperture formed through said interior cover panel of said second book leaf.

2. The cremation urn and keepsake holder of claim 1, further comprising:
a photograph holder formed into said exterior cover panel of said first book leaf, said photograph holder is adapted to receive and display a photograph such that the photograph is facing outwardly from said first book leaf.

3. The cremation urn and keepsake holder of claim 1, wherein said container assembly is capable of being removed from said aperture to allow the filing of said second compartment with cremation remains and then being reinserted into said aperture to seal said aperture.

4. The cremation urn and keepsake holder of claim 3, wherein said container assembly includes:
a container having an open top and a continuous flanged edge extending from and around said open top, said container is received by said aperture so that said flanged edge abuts said interior cover panel of said first leaf and extends beyond the perimeter of said aperture;
a first gasket positioned between a lower surface of said flanged edge and said interior cover panel of said second book leaf;
a cover plate for covering said open top;
a second gasket positioned between a lower surface said cover plate and an upper surface of said flanged edge; and
a fastening means for fastening said container assembly to said interior cover panel to seal said aperture.

5. The cremation urn and keepsake holder of claim 4, wherein said second gasket is sized to completely cover said lower surface of said cover plate.

6. The cremation urn and keepsake holder of claim 5, wherein said second gasket is of a felt material.

7. The cremation urn and keepsake holder of claim 1, wherein said interior cover panel of said first book leaf defines an opening allowing unobstructed access to the interior of said first compartment.

8. The cremation urn and keepsake holder of claim 7, further comprising:
a decorative pillow inserted into said first compartment, and wherein said decorative pillow is of a dimension to substantially fill said opening defined by said interior cover panel of said first book leaf.

9. The cremation urn and keepsake holder of claim 1, wherein said first book leaf and said second book leaf are each of a one piece construction.

10. A cremation urn and keepsake holder having a simulative appearance of a book, comprising:
a first book leaf, said first book leaf includes an exterior cover panel, an interior cover panel, and a peripheral wall that is attached to and extends between said exterior cover panel and said interior cover panel so as to define a first compartment;
a second book leaf hingidly attached to said first book leaf along a common adjacent edge, said first book leaf includes an exterior cover panel, an interior cover panel, and a peripheral wall that is attached to and extends between said exterior cover panel and said interior cover panel so as to define a second compartment for receiving cremation remains, said second compartment is sealed from an exterior environment, said interior cover panel of said second book leaf defining an aperture for placing cremation remains within said second compartment; and
a cover plate, said cover plate is removable attached to said interior cover panel of said second book leaf to seal to seal said aperture.

11. The cremation urn and keepsake holder of claim 10, further comprising:
a photograph holder formed into said exterior cover panel of said first book leaf, said photograph holder is adapted to receive and display a photograph such that the photograph is facing outwardly from said first book leaf.

12. The cremation urn and keepsake holder of claim 10, further comprising:
a container assembly that is adapted to be sealing received by said aperture and covered by said cover plate.

13. The cremation urn and keepsake holder of claim 12, wherein said container assembly includes:
a container having an open top and a continuous flanged edge extending from and around said open top, said container is received by said aperture so that said flanged edge abuts said interior cover panel of said first leaf and extends beyond the perimeter of said aperture;
a first gasket positioned between a lower surface of said flanged edge and said interior cover panel of said second book leaf;
a second gasket positioned between a lower surface said cover plate and an upper surface of said flanged edge; and
a fastening means for fastening said container assembly to said interior cover panel to seal said aperture.

14. The cremation urn and keepsake holder of claim 13, wherein said second gasket is of a dimension to completely cover said lower surface of said cover plate.

15. The cremation urn and keepsake holder of claim 14, wherein said second gasket is of a felt material.

16. The cremation urn and keepsake holder of claim 10, wherein said interior cover panel of said first book leaf defines an opening of a dimension that is substantially equal to an interior perimeter of said first compartment.

17. The cremation urn and keepsake holder of claim 14, further comprising:
a decorative pillow inserted into said first compartment, and wherein said decorative pillow is of a dimension to substantially fill said opening defined by said interior cover panel of said first book leaf.

18. A cremation remains and keepsake holder having construction and a simulative appearance of a book, comprising:
a first book leaf, said first book leaf includes an exterior cover panel, an interior cover panel, and a peripheral wall that is attached to and extends between said exterior cover panel and said interior cover panel so as to define a first compartment, said interior cover panel of said first book leaf defining an aperture providing access to said first compartment;
a second book leaf hingidly attached to said first book leaf along a common adjacent edge, said first book leaf includes an exterior cover panel, an interior cover panel, and a peripheral wall that is attached to and extends between said exterior cover panel and said interior cover panel so as to define a second compartment for receiving cremation remains, said second compartment is sealed from an exterior environment;
a container assembly, said container assembly is adapted to be sealing received by an aperture formed through said interior cover panel of said second book leaf; and
a photograph holder formed into said exterior cover panel of said first book leaf, said photograph holder is adapted to receive and display a photograph such that the photograph is facing outwardly from said first book leaf.

19. The cremation remains and keepsake holder of claim 18, further comprising:
a decorative pillow inserted into said first compartment through said opening defined by said interior panel of said first book leaf.

20. The cremation remains and keepsake holder of claim 18, wherein said container assembly includes:
a container having an open top and a continuous flanged edge extending from and around said open top, said container is received by said aperture so that said flanged edge abuts said interior cover panel of said first leaf and extends beyond the perimeter of said aperture;
a first gasket positioned between a lower surface of said flanged edge and said interior cover panel of said second book leaf;
a cover plate for covering said open top;
a second gasket positioned between a lower surface said cover plate and an upper surface of said flanged edge; and
a fastening means for fastening said container assembly to said interior cover panel to seal said aperture.
